(19) United States
(12) Patent Application Publication
(10) Pub. No.: US 2009/0188115 A1
(43) Pub. Date: Jul. 30, 2009

(54) SNAP-OFF KNIFE

(76) Inventor: Gary E. VAN DEURSEN, Essex, CT (US)

Correspondence Address: MCDERMOTT WILL & EMERY LLP, 600 13TH STREET, N.W., WASHINGTON, DC, 20005-3096, US

(21) Appl. No.: 12/363,379

(22) Filed: Jan. 30, 2009

Related U.S. Application Data
(60) Provisional application No. 61/006,748, filed on Jan. 30, 2008.

(51) Int. Cl. B26B 3/06

(52) U.S. Cl. 30/162

(57) ABSTRACT

A snap-off knife is provided, having a metal sleeve, a blade contained within the metal sleeve and slidably extendable through a first terminal end of the metal sleeve, and a cap having a cavity such that the cap is capable of fitting over the first terminal end of the metal sleeve from which the blade extends. The metal sleeve also has an open section for allowing a slide button to move along the open section of the metal sleeve in a direction parallel to the direction that the blade extends and retracts. The cap has a narrow slot for placing over the exposed portion of the blade while the blade is being snapped off by the user. The cap is capable of fitting over a second terminal end of the metal sleeve located opposite the first terminal end.

### CROSS REFERENCE TO PROVISIONAL APPLICATION

This application is based upon and claims the benefit of priority from Provisional U.S. Patent Application 61/006,748 (Attorney docket No. 044208-0037) filed on Jan. 30, 2008, the entire contents of which are incorporated by reference herein.

### TECHNICAL FIELD

The present disclosure relates to a knife having a snap-off blade. The present disclosure has particular applicability to knives with disposal blades.

### BACKGROUND

Retractable sharp instruments are well known in the art. For example, U.S. Pat. No. 7,314,471 describes a scalpel which is provided having a handle with a longitudinally extending cavity therein, a blade carrier within the cavity and movable longitudinally relative to the handle between an operative position in which a blade carried thereby is exposed for use at an open end of the cavity and an inoperative position in which a blade carried thereby is retracted within the cavity in the handle.

One type of retractable blade is the snap-off knife. In a snap-off knife, the blades are typically stacked in a metal sleeve. A slide button on the side is used to extend the blade out of the bottom. The blade has break lines formed into it. When the blade gets dull, the user snaps off the old blade section exposing a fresh blade. To snap it off, it is often just pushed against a hard surface until it breaks. For example, U.S. Pat. No. 4,063,356 relates to hand knives of the type comprising a hand grip which houses a strip steel blade with snap-off ends, which when worn can be removed to reveal a fresh operative blade tip. However, breaking the blade off has been a major safety concern for many users.

Other known knives of this type, for adjusting the position of the blade relative to the hand grip to vary the amount of projection of the tip of the blade from the leading end of the grip, require dismantling and opening up the hand grip, in a laborious operation, to allow the blade to be re-set.

### SUMMARY OF THE DISCLOSURE

To overcome the above-mentioned problems, the present disclosure is directed towards a snap-off knife that includes a safety cap for guarding against accidental exposure of the blade, and providing a safe method of breaking the blade.

One embodiment is directed to a snap-off knife comprising a metal sleeve, a blade contained within the metal sleeve and slidably extendable through a first terminal end of the metal sleeve to expose a portion of the blade, and a cap having a cavity such that the cap is capable of fitting over the first terminal end of the metal sleeve from which the blade extends. Additionally, the cap has a narrow slot for placing over the exposed portion of the blade and snapping off the exposed portion of the blade when the cap is grasped by the user. In another embodiment, the cavity in the cap is capable of fitting over a second terminal end of the metal sleeve located opposite the first terminal end of the metal sleeve.

In another embodiment, the blade contains a plurality of linear indentations each of which extend along substantially the entire width of the blade. The snap-off knife is additionally equipped with a slide button attached to the blade. Other embodiments of the metal sleeve have an open section for allowing the slide button to move along the open section of the metal sleeve in a direction parallel to the direction that the blade extends and retracts from the metal sleeve.

In another embodiment, the metal sleeve has a plurality of equally spaced ridges along the open section of the metal sleeve. The metal sleeve may additionally be equipped with a pocket clip for clipping the knife to a planar or semi-planar surface.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a top elevational view of a snap-off knife according to an embodiment of the present disclosure.

FIG. 2 is a rear elevational view of a snap-off knife according to an embodiment of the present disclosure;

FIG. 3 is a top elevational view of a snap-off knife according to an embodiment of the present disclosure;

FIG. 4 is a front elevational view of a snap-off knife according to an embodiment of the present disclosure, and

FIG. 5 is a front perspective view of a snap-off knife according to an embodiment of the present disclosure.

### DETAILED DESCRIPTION

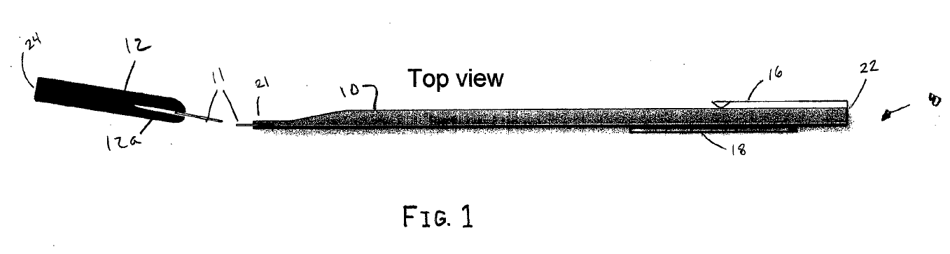

FIG. 1 is a top view of the knife of one embodiment of the present disclosure. The disclosed knife 8 includes a metal sleeve 10. The metal sleeve has an opening at a first terminal end 21, from which a snap-off blade 11 may extend.

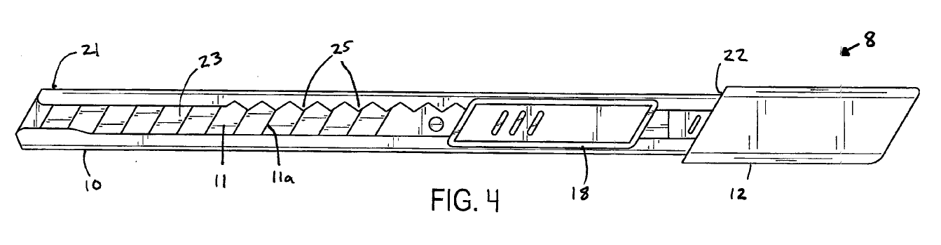

FIG. 4 shows a front view of the knife 8. In this view, the open portion 23 of the metal sleeve 10 is shown, through which the snap-off blade 11 can be seen. This view also displays the blade 11 having indentions 11a or the like, which can extend from one side of the blade to the other. These indentations 11a allow for specific portions of the blade 11 to be snapped off when the user deems it necessary to have a new sharp edge on the blade 11.

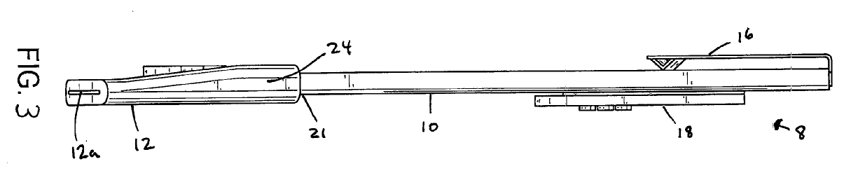

FIG. 3 shows a knife with a protective cap 12 having a cavity 24 which fits over the first terminal end 21 of the metal sleeve 10. In this position, the cap 12 covers the end of the blade 11 which extends out from the first terminal end 21 of the metal sleeve 10. In this way, the cap 12 protects the user from inadvertent cuts which may occur from an exposed end of the blade. FIG. 4 is a top view of the knife 8 with the cap 12 removed from the first terminal end 21 and placed on a second terminal end 22 while the knife 8 is in use.

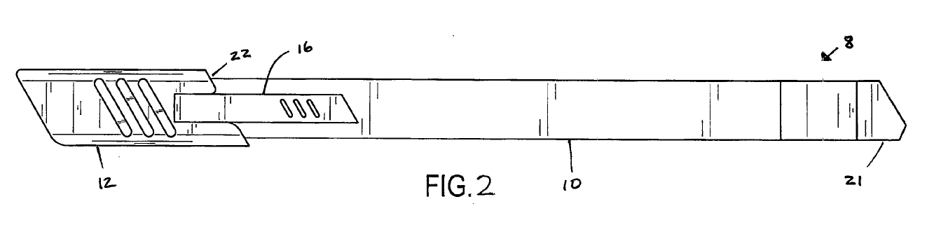

The cap 12 is optionally designed to fit over certain embodiments of the knife which contain a pocket clip 16. FIG. 2 is a back view of the knife 8 which shows the pocket clip 16 attached to the metal sleeve 10 at the second terminal end 22. The pocket clip 16 extends along the length of the metal sleeve 10 for a distance sufficient to allow the knife 8 to be clipped onto a planar or semi-planar surface, such as a shirt or pants pocket, an end of a bag, or a similarly shaped object on which the user may desire to store the knife 8.

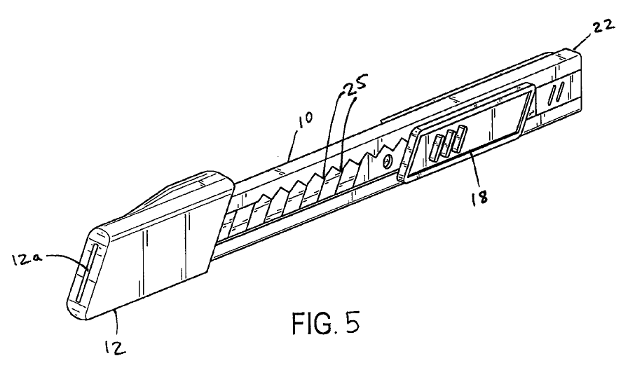

In another embodiment, the protective cap 12 has a slot 12a, the width of which is greater than the thickness of the blade 11. As shown in FIG. 1, the slot 12a is placed over the blade 11 while the user grasps the cap 12, allowing the user to snap off the blade 11, while preventing exposure of the user's fingers and hands to the blade 11. In one embodiment such as shown in FIG. 3, the slot 12a can be located at the end of the cap 12 opposite to the cavity 24. In this embodiment, the slot 12a extends along the entire width of the cap 12. However, other embodiments of the knife feature a slot 12a that do not extend the entire width of the cap 12. In these embodiments, such as that shown in FIGS. 3 and 5, the slot 12a should be wide enough to allow for the blade 11 to fit inside the slot 12a to allow for breaking of the blade 11.

As is shown in FIGS. 4 and 5, the knife also comprises a slide button 18 attached to the blade 11. The slide button 18 allows the user to move and lock the blade 11 at a point along the length of the metal sleeve 10. This is accomplished by use of a series of teeth 25 which extend laterally outward from the edge of the open portion of the metal sleeve 10. The teeth 25 are spaced at regular intervals along the edge of the metal sleeve 10. This arrangement is such that as the slide button 18 is moved in either direction along the length of the metal sleeve 10, the slide button 18 will sequentially engage the spaces in between each tooth 25 to hold the blade 11 at a set position. In this way, the amount of blade 11 exposed from the metal sleeve 10 can be controlled.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A snap-off knife comprising
a metal sleeve;
a blade contained within the metal sleeve, wherein the blade is slidably extendable through a first terminal end of the metal sleeve to expose a portion of the blade; and
a cap having a cavity such that the cap is capable of fitting over the first terminal end of the metal sleeve from which the blade extends,
the cap further comprising a narrow slot for placing over the exposed portion of the blade and snapping off the exposed portion of the blade when the cap is grasped by the user.

2. The snap-off knife of claim 1, wherein the blade contains a plurality of linear indentations each of which extend along substantially the entire width of the blade.

3. The snap-off knife of claim 1, further comprising a pocket clip for clipping the knife to a planar or semi-planar surface.

4. The snap-off knife of claim 3, wherein the cap is also capable of fitting over a second terminal end of the metal sleeve located opposite the first terminal end of the metal sleeve.

5. The snap-off knife of claim 1, wherein the metal sleeve contains a plurality of equally spaced teeth along the open section of the metal sleeve.

6. The snap-off knife of claim 1, further comprising a slide button attached to the blade.

7. The snap-off knife of claim 6, wherein the metal sleeve has an open section for allowing the slide button to move along the open section of the metal sleeve in a direction parallel to the direction that the blade extends and retracts from the metal sleeve.

8. A snap-off knife comprising
a metal sleeve;
a blade contained within the metal sleeve, wherein the blade is slidably extendable through a first terminal end of the metal sleeve;
a slide button attached to the blade; and
a cap having a cavity capable of fitting over the first terminal end of the metal sleeve from which the blade extends and capable of fitting over a second terminal end of the metal sleeve located opposite the first terminal end of the metal sleeve,
wherein the metal sleeve has an open section for allowing the slide button to move along the open section of the metal sleeve in a direction parallel to the direction that the blade extends and retracts from the metal sleeve,
the metal sleeve contains a plurality of equally spaced teeth along the open section of the metal sleeve,
the cap further comprising a narrow slot for placing over the exposed portion of the blade and snapping off the exposed portion of the blade when the cap is grasped by the user, and
the blade contains a plurality of linear indentations each of which extend along substantially the entire width of the blade.
